(19) United States
(12) Patent Application Publication
(10) Pub. No.: US 2013/0120602 A1
(43) Pub. Date: May 16, 2013

(54) Taking Photos With Multiple Cameras

(71) Applicant: Ziji Huang, Kenmore, WA (US)

(72) Inventor: Ziji Huang, Kenmore, WA (US)

(73) Assignee: MICROSOFT CORPORATION, Redmond, WA (US)

(21) Appl. No.: 13/295,289

(22) Filed: Nov. 14, 2011

(51) Int. Cl. H04N 5/225

(52) U.S. Cl. 348/218.1; 348/E05.024

(57) ABSTRACT

Various embodiments utilize multiple built-in cameras on a mobile device, e.g., a phone, to capture images, individuals of which include a portion from each of the cameras. The ratio and layout of the portions from different cameras can be adjusted before the image is captured and stored. In at least some embodiments, individual cameras face different directions, and images captured by one of the cameras can be incorporated into images captured by another of the cameras. For example, in at least some embodiments, particularly those in which a user's image is captured, the user's image can be extracted from the view of a first camera, such as a front-facing camera on a mobile device, and displayed to a user in the foreground of the image captured by a second camera, such as a landscape image captured by a back-facing camera on the mobile device.

### BACKGROUND

Many cell phones are equipped with cameras which users frequently use to take photographs of themselves and others in various locations. In order to obtain photographs of themselves, users can either take the photo themselves, or they can attempt to find another person to take the photo for them. When a user attempts to take the photo on his or her own, the user can appear very large in the photo, in contrast to the scene in the background. It can also be difficult to aim the camera properly and ensure that the lighting is acceptable. This can result in photos that are not centered properly or that cut out one or more of the subjects of the photo.

If a user can find another person to take the photo, the user does not have the option of controlling the layout of the photo, and can end up with photos that are not what the user was seeking. For example, a couple wanting a photo in front of the Gateway Arch in St. Louis may end up with a photo that eliminates the top of the arch because the photographer assumed the couple should be the primary focus of the photo, while the couple really wanted the entire Arch in the photo. Furthermore, there are not always others around who are willing or able to take a photo.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments utilize multiple built-in cameras on a mobile device, e.g., a phone, to capture images, individuals of which include a portion from each of the cameras. The ratio and layout of the portions from different cameras can be adjusted before the image is captured and stored. In at least some embodiments, individual cameras face different directions, and images captured by one of the cameras can be incorporated into images captured by another of the cameras. For example, in at least some embodiments, particularly those in which a user's image is captured, the user's image can be extracted from the view of a first camera, such as a front-facing camera on a mobile device, and displayed to a user in the foreground of the image captured by a second camera, such as a landscape image captured by a back-facing camera on the mobile device. The user can adjust the ratio and layout of the images relative to one another and capture the image in a file.

### BRIEF DESCRIPTION OF THE DRAWINGS

While the specification concludes with claims particularly pointing out and distinctly claiming the subject matter, it is believed that the embodiments will be better understood from the following description in conjunction with the accompanying figures, in which:

FIG. 1 is an illustration of an example operating environment in accordance with one or more embodiments;

FIG. 2 is an illustration of an example implementation in accordance with one or more embodiments;

FIG. 3 is an illustration of an example implementation in accordance with one or more embodiments;

FIG. 4 is an illustration of an example implementation in accordance with one or more embodiments;

FIG. 5 is a flow diagram of an example method in accordance with one or more embodiments; and

FIG. 6 is a block diagram of an example device that can be used to implement one or more embodiments.

### DETAILED DESCRIPTION

Overview

Various embodiments utilize multiple built-in cameras on a mobile device, e.g., a phone, to capture images, individuals of which include a portion from each of the cameras. The ratio and layout of the portions from different cameras can be adjusted before the image is captured and stored. In at least some embodiments, individual cameras face different directions, and images captured by one of the cameras can be incorporated into images captured by another of the cameras. For example, in at least some embodiments, particularly those in which a user's image is captured, the user's image can be extracted from the view of a first camera, such as a front-facing camera on a mobile device, and displayed to a user in the foreground of the image captured by a second camera, such as a landscape image captured by a back-facing camera on the mobile device. The user can adjust the ratio and layout of the images relative to one another and capture the image in a file.

In the discussion that follows, a section entitled “Example Operating Environment” describes an operating environment in accordance with one or more embodiments. Next, a section entitled “Example Embodiment” describes various examples that utilize a multi-camera mobile device, e.g., a dual-camera device, to capture an image that includes portions from each of the cameras. Finally, a section entitled “Example Device” describes an example mobile device that can be used to implement one or more embodiments.

Consider, now, an example operating environment in accordance with one or more embodiments.

Example Operating Environment

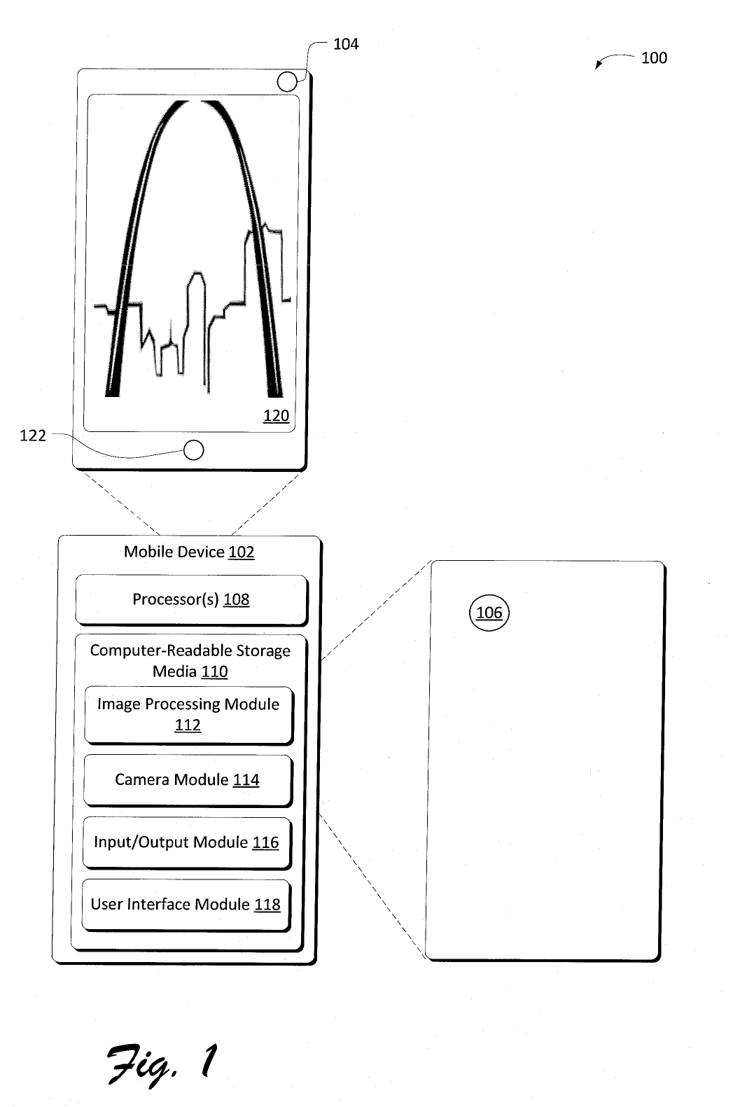

FIG. 1 is an illustration of an example environment 100 in accordance with one or more embodiments. Environment 100 includes a handheld, mobile device 102 that is equipped with multiple cameras. In at least some embodiments, at least some of the multiple cameras can face different directions. Any suitable number of cameras can be utilized and positioned to face any suitable direction. By way of example and not limitation, mobile device 102 includes a front-facing camera 104 and a back-facing camera 106. Thus, in this example, the cameras face in generally opposite directions. In various embodiments, a user can take a photograph that utilizes image portions from both front-facing camera 104 and back-facing camera 106. The mobile device 102 can be implemented as any suitable type of device, examples of which are provided below.

In the illustrated and described embodiment, mobile device 102 includes one or more processors 108 and computer-readable storage media 110. Computer-readable storage media 110 can include various software executable modules, including image processing module 112, camera module 114, input/output module 116, and a user interface module 118. In this particular example, image processing module is configured to extract a close image, such as an image of the user, from a first camera and display the extracted image on an image from a second camera. Camera module 114 is configured to control the cameras, and can cause the cameras to capture respective images.

Input/output module 116 is configured to enable the mobile device 102 to receive communications and data from, and transmit communications and data to, other devices, such as mobile phones, computers, and the like. The input/output module 116 can include a variety of functionality, such as functionality to make and receive telephone calls, form short message service (SMS) text messages, multimedia messaging service (MMS) messages, email messages, status updates to be communicated to a social network service, and so on.

The user interface module 118 is configured to manage user interfaces associated with executable modules that execute on the device. In the illustrated and described embodiment, user interface module 118 can, under the influence of image processing module 112, cause images within the view of cameras 104 and 106 to be presented to a user along with tools that can enable a user to adjust the images to achieve a desired combined image.

Mobile device 102 also includes a display 120 disposed on the front of the device that is configured to display content, such as the images of the cameras 104 and 106 produced by image processing module 112. Display 120 may be used to output a variety of content, such as a caller identification (ID), contacts, images (e.g., photos), email messages, multimedia messages, Internet browsing content, game play content, music, video, and so on. In one or more embodiments, the display 120 is configured to function as an input device by incorporating touchscreen functionality, e.g., through capacitive, surface acoustic wave, resistive, optical, strain gauge, dispersive signals, acoustic pulse, and other touchscreen functionality. The touchscreen functionality (as well as other functionality such as track pads) may also be used to detect gestures or other input.

In practice, image processing module 112 can extract an image, such as an image of the user, from an image taken by the front-facing camera and display the extracted image on or over the image from the back-facing camera. For example, a user can point the back-facing camera on mobile device 102 to a view of a landscape, while the front-facing camera on mobile device 102 is pointed at the user. The image processing module 112 can extract the image of the user from the image taken by the front-facing camera on the mobile device, and overlay the image of the user on the image of the landscape. The user can then take the photo by selecting a user instrumentality shown on the display 120 or a mechanical button 122 on the mobile device.

Camera module 114 can include one or more camera lenses that collect rays of light from an object for photographing the object, a sensor that converts the photographed optical signal into an electrical signal, a range-finding sensor, and a signal processor that converts an analog image signal output from the camera sensor to digital data. The camera sensor can be, for example, a charge coupled device (CCD) sensor. The signal processor can be, for example, a digital signal processor (DSP). The camera sensor, the range-finding sensor, and the signal processor can be integrated into a signal unit or can be separate devices. Any suitable camera or cameras can be used without departing from the spirit and scope of the claimed subject matter.

In various embodiments, camera module 114 can include at least two camera lenses. The lenses can be located on opposite facing surfaces of the mobile device 102 (e.g., a lens for front-facing camera 104 and a lens for back-facing camera 106). In alternative embodiments, mobile device 102 can include two camera modules 114 and each can include a single camera lens. For simplicity, processes will be described assuming that camera module 114 includes at least two camera lenses, though it is to be appreciated and understood that multiple camera modules can be included in place of a single integrated camera module.

In practice, image processing module 112 can enable camera module 114 to present a preview of images that can be captured using front-facing camera 104 and back-facing camera 106. In various embodiments, the preview can be a live preview, and can be updated as a user moves the device. This can result in a change in the image that can be captured by the device's cameras.

Camera module 114 can transmit information and/or data gathered by the above-mentioned sensors to image processing module 112 for further processing. Specifically, image processing module 112 can utilize the information and/or data from the camera module to extract a close image from one of the cameras, such as the front-facing camera 104. For example, the image processing module 112 can receive digital data including data on the distance of various objects in the image viewed by the front-facing camera 104 to enable the image processing module 112 to extract an image of the user from a view from front-facing camera 104 that includes the image of the user and the background in front of which the user is located. In other words, the image processing module 112 can use information from the range-finding sensor to extract a representation of an object that is close to the camera.

The image processing module 112 can then display the extracted image of the user on the image captured by the back-facing camera 106, as described above and below. In various embodiments, the view of the front-facing camera 104 is taken in a direction that is different from the view taken by the second camera. In other words, in the presently-described embodiment, the images from the cameras do not overlap or contain any of the same points. As described above and below, the user can adjust the displayed image before it is captured, such as by altering the ratio of the size of an image obtained by one camera relative to size of the image obtained by another camera, or the placement of one image relative to the other. When a user indicates a desire to capture the image as it is displayed, the camera module 114 can cause the image to be captured using both cameras. In various embodiments, the cameras capture their respective portions of the image substantially simultaneously, although it should be appreciated and understood that the cameras can capture their respective portions of the image at different points in time. The image, including at least a portion from the front-facing camera and at least a portion from the back-facing camera, can be stored as a single file on the mobile device 102.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable memory devices. The features of the user interface techniques described below are platform-independent, meaning that the techniques may be implemented on a variety of commercial computing platforms having a variety of processors.

The example environment described can be appreciated with respect to the following example embodiments that employ multiple built-in cameras on a mobile device to capture and process images.

### Example Embodiment

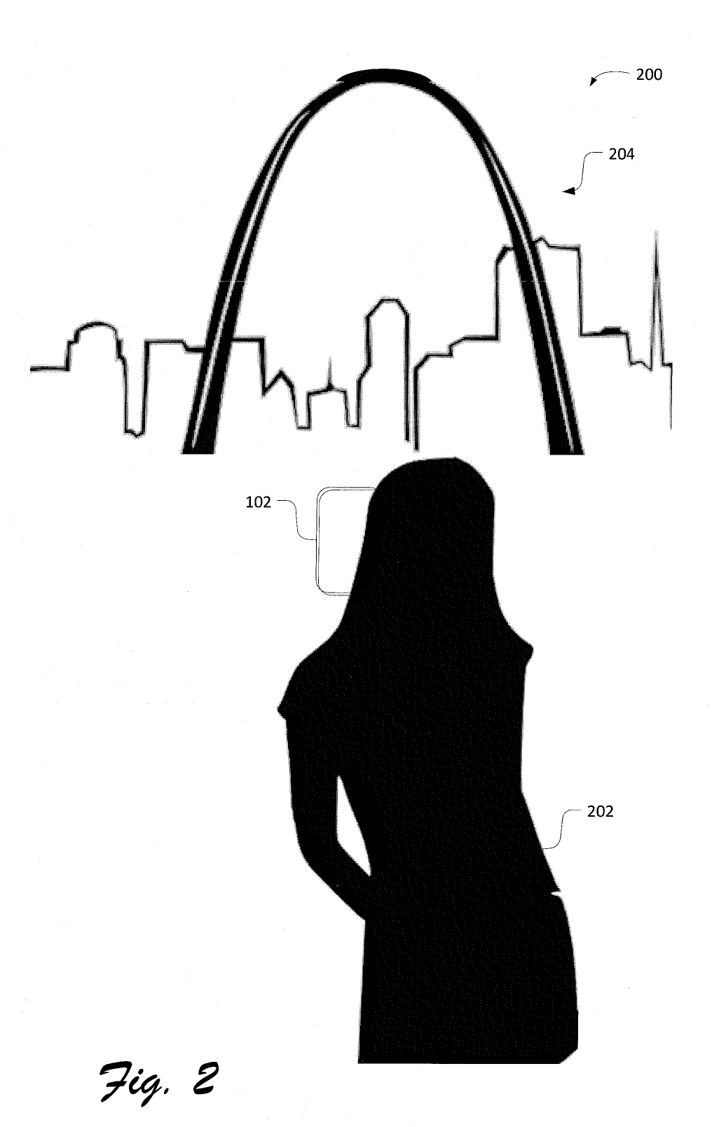

FIG. 2 is an illustration of an example embodiment 200 in which a user 202 is employing a mobile device 102 to capture a view 204. In this example, there are two distance relationships that are relevant. Specifically, in the embodiment illustrated, the view 204 is a view of the Gateway Arch in St. Louis, and the user is located a sufficient distance away in order to capture an image of the entire Arch. The user 202 is also located a second, shorter distance from the mobile device 102. The distance between user 202 and the mobile device 102 can be, for example, about an arm's length, while the distance between the user and the Arch is much greater, such as one hundred yards or more.

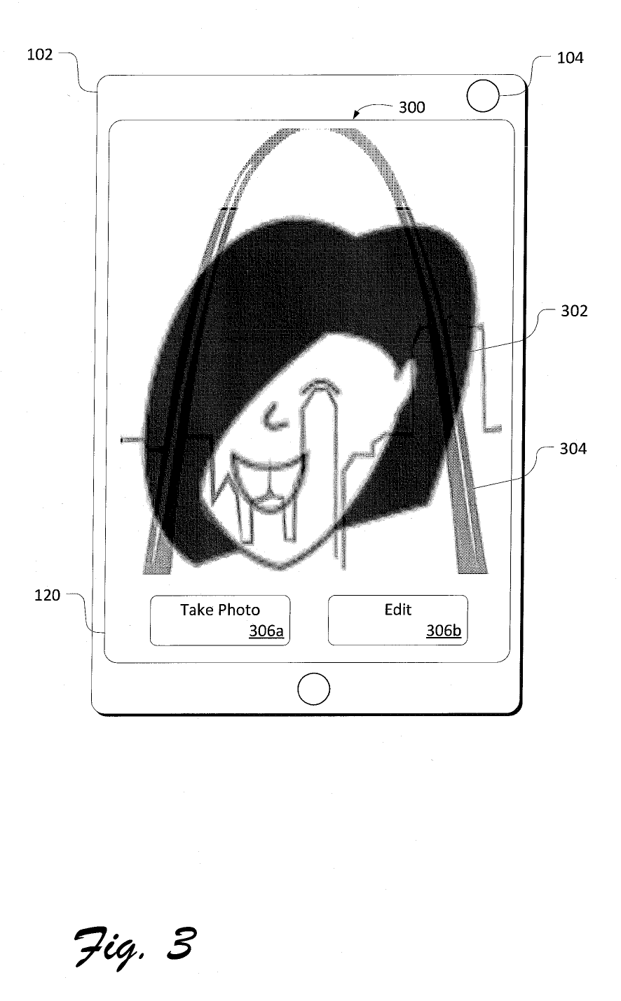

Mobile device 102 is configured to display both an image of the user 202 (such as provided by front-facing camera 104) and an image of the view (such as provided by the back-facing camera 106). An example display presenting a coalesced image is shown in FIG. 3.

There, mobile device 102 includes an example coalesced image 300 that is presented on display 120. The coalesced image represents an extracted representation or image of user 302 overlaid on background image 304. The extracted representation of the user 302 can be extracted from an image taken by the front-facing camera 104. This can be done in any suitable way. For example, a range-finding sensor can identify one or more objects, such as the user, in the foreground of a view and extract that object from the remaining portion of the view. In various embodiments, the range-finding sensor can provide data to enable the image processing module to determine at least one object within close range of the device and enable extraction of the representation from the remaining portion of the view. “Close range” can vary depending on the particular embodiment. For example, in some embodiments, representations of objects within one meter or less can be extracted from the view from a camera.

Because the user is much closer in distance to the mobile device 102 than to the background, the extracted representation of the user 302 can be disproportionate compared to the background image 304. Therefore, one or more user instrumentalities (e.g., “Take Photo” user instrumentality 306a and “Edit” user instrumentality 306b) can be provided on the display 120 to enable the user to edit or accept the photo as it appears on the display by selecting the corresponding instrumentality. As but one example of how editing functionality can be employed, consider the following.

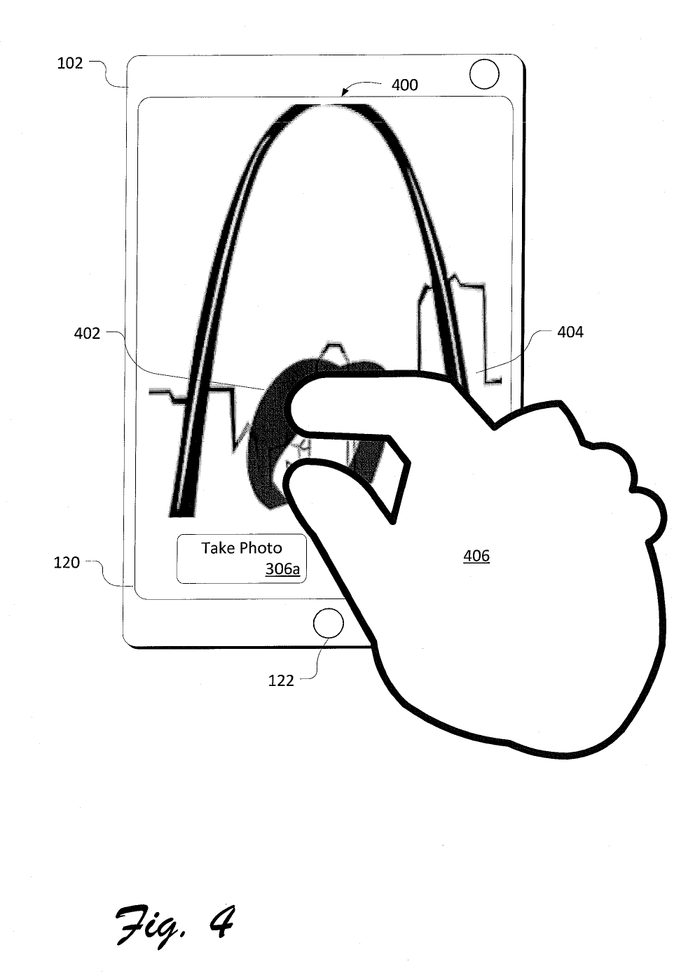

FIG. 4 is an illustration of an example coalesced image 400 that is presented on display 120, for example, when a user has chosen to edit the coalesced image before taking the photo. In FIG. 4, a user can interact with the coalesced image on the display 120 and modify the properties and characteristics of the image displayed. This can be done in any suitable way. For example, a user can alter the ratio of the size of extracted representation of the user 402 relative to size of the background image 404. This can be achieved through the use of one or more menus presented on the display 120 or through various gestures, represented by a user's hand 406. Gestures can include, for example a “pinch” gesture to cause the size of the extracted representation of the user 402 to be reduced relative to the background image 404. Alternately or additionally, a “spread” gesture can be utilized to cause the size of the extracted representation of the user 402 to be enlarged relative to the background image 404. Other gestures, such as a drag, can be utilized to move the images relative to one another. Still other gestures can additionally be incorporated, without departing from the spirit and scope of the claimed subject matter. For example, gestural input can be utilized to cause changes in color, hue, intensity, contrast, and the like.

Once the overall image appears suitable to the user, the user can interact with the mobile device 102 to capture the image. For example, the user can select a user instrumentality, such as the user instrumentality 306a labeled “Take Photo,” or can select mechanical button 122 to cause the device to more permanently capture the image such as by storing it as a file in memory.

Having described various embodiments of using dual built-in cameras on a mobile device to integrate multiple images into a single photo, consider now methods for creating an image using multiple cameras.

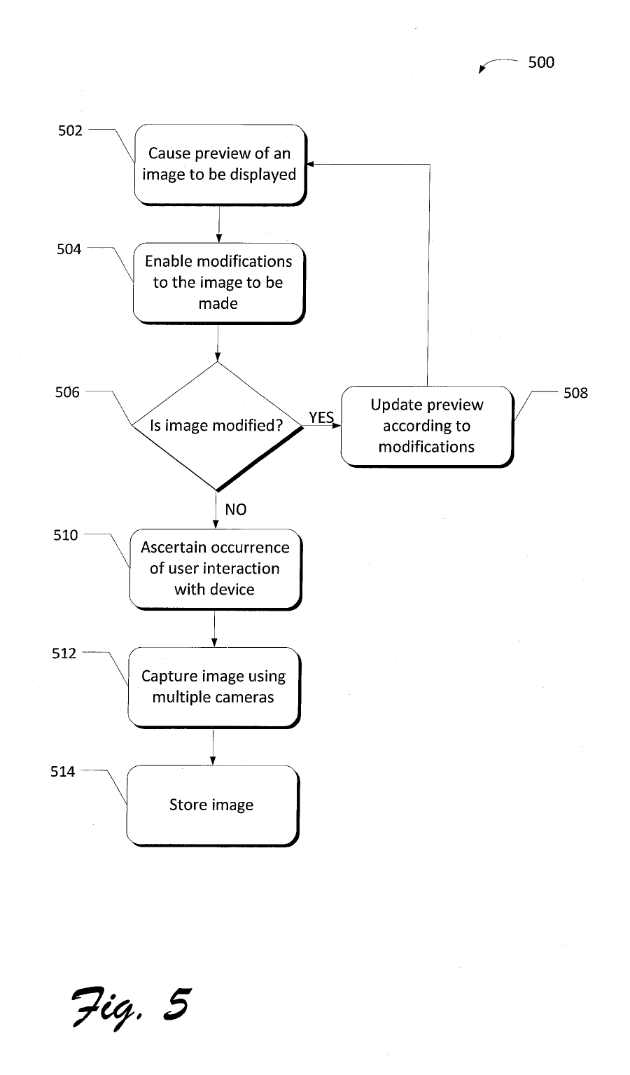

FIG. 5 is a flow diagram of a process 500 in accordance with one or more embodiments. The process can be implemented in connection with any suitable hardware, software, firmware, or combination thereof. In at least some of the embodiments, the process can be implemented by a mobile device, such as mobile device 102. Any suitable type of mobile device can be utilized examples of which are provided above.

Block 502 causes a preview of an image to be displayed. This can be performed in any suitable way. For example, assume a user is holding a mobile device with a first camera facing him, and a second camera facing the opposite direction (i.e., the second camera is facing the same direction that the user is facing). An image can be displayed, as described above, that includes an image portion from the first camera (such as an image or representation of the user) and an image portion from a second camera (such as a view of the Gateway Arch).

In various embodiments, the portion of the image from at least one of the cameras is a representation of an object that was extracted from the view from that particular camera. The extracted image portion is overlaid on the portion of the image from the other camera. The representation of the object from a given view can be based, for example, on information on the distance of the object from the camera provided by a range-finding sensor or a distance relationship. In various embodiments, representations of objects within about one meter or less can be extracted from a view. Examples of how this can be done are provided above.

Block 504 enables modifications to the image to be made. This can be done in any suitable way. For example, various user instrumentalities can be displayed to enable a user to change the ratio of the size of one of the image portions relative to the other image portions (e.g., make the image of the user smaller relative to the background image), adjust the placement of one image portion relative to the other (e.g., move the image of the user to the left or to the right), zoom in or out on one of the image portions, or the like. Other modifications an image's properties and characteristics can be made, depending on the particular embodiment.

Block 506 ascertains whether the image has been modified. This can be done in any suitable way. For example, the device can ascertain the occurrence of a user action, such as a dragging gesture on a touch-enabled display. If the image has been modified, block 508 updates the preview of the image according to the modifications. This can be done in any suitable way. For example, the preview can be a “live” preview that updates in real-time as the modifications are being made. Once the preview is updated, the process returns to block 502 until there are no further modifications to the image.

When there are no modifications to the image (or no further modifications to the image) (e.g., a “no” at block 506), block 510 can ascertain the occurrence of a user interaction with the device indicating a desire to capture the image. This can be done in any suitable way. For example, the device can detect that a user has interacted with a user instrumentality labeled “Take Picture” or that a user has pushed a mechanical button on the device.

Block 512 captures the image using multiple cameras. This can be performed in any suitable way. For example, the device can include hardware configured to enable multiple cameras to capture a portion of the image substantially simultaneously or within 3-5 seconds of one another. The time can vary according to the particular embodiment, but should result in a single image file being generated.

Block 514 stores the image. This can be performed in any suitable way. For example, the image can be stored on a secure digital (SD) card or in device memory. In various embodiments, the image is stored as one file, despite including portions of the image obtained from multiple cameras.

The various embodiments of capturing an image using multiple cameras can be implemented using a variety of devices, such as the one described in the following example.

Example Device

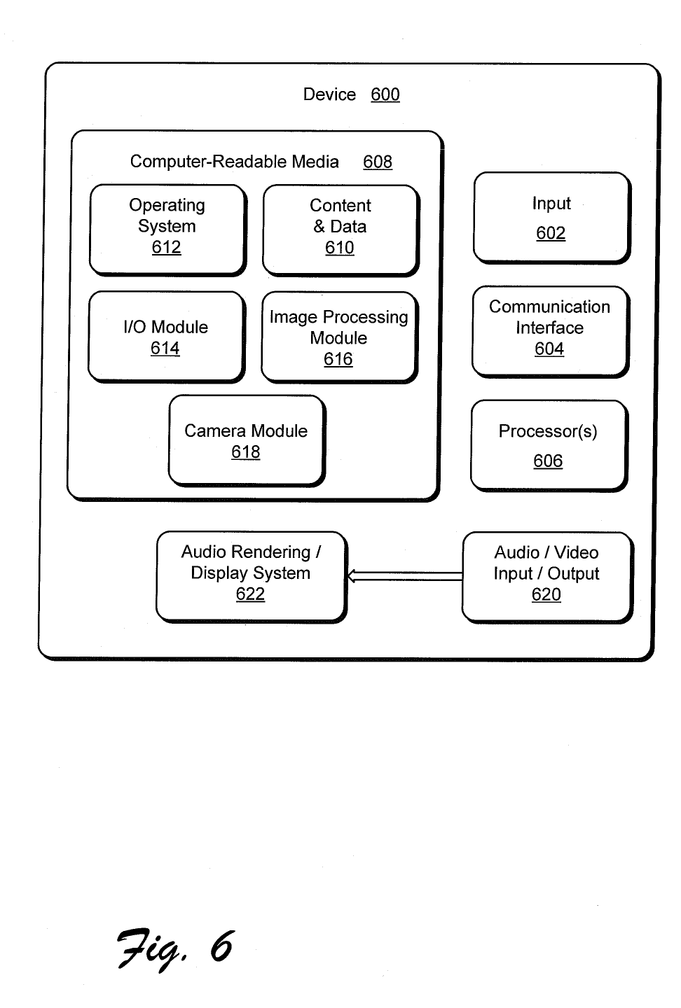

FIG. 6 illustrates various components of an example device 600 that can be used to implement one or more of the embodiments described above. In one or more embodiments, device 600 can be implemented as a user device, such as mobile device 102 in FIG. 1.

Device 600 includes input device 602 that may include Internet Protocol (IP) input devices as well as other input devices, such as a keyboard. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface can enable device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610 as well as device executable modules and any other types of information and/or data related to operational aspects of device 600. One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random access memory (RAM), read-only memory (ROM), an optical disc, flash memory, hard disk memory, and other memory devices that may use magnetic, optical, and other techniques to store instructions and other data. The storage type computer-readable media are explicitly defined herein to exclude propagated data signals.

An operating system 612 can be maintained as a computer executable module with the computer-readable media 608 and executed on processor 606. Device executable modules can also include an I/O module 614 (which may be used to provide telephonic functionality) in addition to an image processing module 616 and a camera module 618 that operate as described above and below.

Device 600 also includes an audio and/or video input/output 620 that provides audio and/or video data to an audio rendering and/or display system 622. For example, audio and/or video input/output 620 can cause a preview of an image or a captured image to be displayed on audio rendering and/or display system 622. The audio rendering and/or display system 622 can be implemented as integrated component(s) of the example device 600, and can include any components that process, display, and/or otherwise render audio, video, and image data. The audio rendering and/or display system 622 can include functionality to cause captured images or previews of images to be displayed to a user, such as on display 120.

In various embodiments, the device, via audio/video input/output 620 and/or input 602 can sense a user interaction with the mobile device, such as when a user interacts with a user instrumentality displayed by audio rendering/display system 622, and can capture images or perform other actions responsive to such user interactions.

As before, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer-readable storage devices. The features of the techniques described above are platform-independent, meaning that the techniques may be implemented on a variety of commercial computing platforms having a variety of processors.

While various embodiments have been described above, it should be understood that they have been presented by way of example, and not limitation. It will be apparent to persons skilled in the relevant art(s) that various changes in form and detail can be made therein without departing from the scope of the present disclosure. Thus, embodiments should not be limited by any of the above-described exemplary embodiments, but should be defined only in accordance with the following claims and their equivalents.

What is claimed is:

1. A computer-implemented method comprising:
causing, on a mobile device, a preview of an image to be displayed, the image comprising at least a first portion obtained from a first camera on the mobile device, and a second portion obtained from a second camera on the mobile device;
enabling one or more modifications to be made to the preview of the image; and
capturing the image by capturing the first portion of the image with the first camera and capturing the second portion of the image with the second camera.

2. The computer-implemented method of claim 1 further comprising:
storing at least the first portion of the image and the second portion of the image as one file.

3. The computer-implemented method of claim 1, wherein said enabling comprises enabling one or more modifications to be made to the preview of the image prior to capturing the image.

4. The computer-implemented method of claim 3, wherein the one or more modifications comprise modifications to one or more of: a ratio of a size of the first portion of the image relative to a size of the second portion of the image, or a placement of the first portion of the image relative to the second portion of the image.

5. The computer-implemented method of claim 1, further comprising:
obtaining the first portion of the image by extracting a representation of at least one object from a view taken by the first camera.

6. The computer-implemented method of claim 5, causing a preview of an image to be displayed comprising causing the first portion of the image to be displayed as overlaid on the second portion of the image.

7. The computer-implemented method of claim 6, the view from the first camera being taken in a direction that is different from a view taken by the second camera.

8. A mobile device comprising:
one or more processors;
one or more computer-readable storage media;
a first camera located on the device;
at least a second camera located on the device; and
one or more modules embodied on the one or more computer-readable storage media and executable under the influence of the one or more processors, the one or more modules configured to enable images captured by said first camera and said at least second camera to be coalesced into a coalesced image that includes portions from each captured image.

9. The mobile device of claim 8, the one or more modules further configured to cause a preview of the coalesced image to be displayed.

10. The mobile device of claim 9, the one or more modules configured to enable one or more modifications to be made to the coalesced image based on the preview.

11. The mobile device of claim 10, wherein the modifications comprise one or more of modifications to: a ratio of a size of one of the captured images relative to the other of the captured image, or placement of one of the captured images relative to the other of the captured images.

12. The mobile device of claim 8, the one or more modules further configured to:
detect, using a range-finding sensor, an object within a view from the first camera;
extract a representation of the object from the view from the first camera, the representation of the object extracted comprising a portion that is to be coalesced as part of the coalesced image; and
overlay the first portion on a second portion captured by the second camera.

13. The mobile device of claim 8, wherein:
said first camera is located on a first face of the device; and
said second camera is located on a second, opposite face of the device.

14. One or more computer-readable storage media comprising instructions that are executable to cause a device to perform a process comprising:
causing a preview of an image to be displayed, the image comprising at least a first portion obtained from a first camera facing a first direction relative to mobile device with which the first camera is associated, and a second portion obtained from a second camera facing a second, different direction relative to the mobile device, the first portion including at least one object selected based on a distance relationship with the mobile device; and
storing the image on the mobile device.

15. The one or more computer-readable storage media of claim 14, further comprising enabling one or more modifications to be made to the preview of the image prior to storing the image.

16. The one or more computer-readable storage media of claim 15, wherein the different direction is generally opposite the first direction.

17. The one or more computer-readable storage media of claim 16, the causing a preview of an image to be displayed comprising causing the first portion of the image to be displayed as overlaid relative to the second portion of the image.

18. The one or more computer-readable storage media of claim 16, wherein the distance relationship is about one meter or less.

19. The one or more computer-readable storage media of claim 18, the causing a preview of an image to be displayed comprising causing the first portion of the image to be displayed as overlaid relative to the second portion of the image.

20. The one or more computer-readable storage media of claim 19, wherein the one or more modifications comprise modification to one or more of: a size ratio of the image portions or a relative placement of the image portions.
